(19) United States
(12) Patent Application Publication
(10) Pub. No.: US 2024/0286499 A1
(43) Pub. Date: Aug. 29, 2024

(54) METHOD FOR OPERATING A COMMERCIAL VEHICLE HAVING A FUEL CELL SYSTEM AND AN ELECTROMOTIVE DRIVE, AND COMMERCIAL VEHICLE HAVING SAME

(71) Applicant: ZF CV Systems Global GmbH, Bern (CH)

(72) Inventor: Janik Ricke, Uetze (DE)

(21) Appl. No.: 18/656,360

(22) Filed: May 6, 2024

Related U.S. Application Data
(63) Continuation of application No. PCT/EP2022/080471, filed on Nov. 2, 2022.

(30) Foreign Application Priority Data
Nov. 4, 2021 (DE) 10 2021 128 751.0

(51) Int. Cl. B60L 50/72; B60L 58/33; H01M 8/04746; H01M 8/04858

(52) U.S. Cl. CPC B60L 50/72; B60L 58/33; H01M 8/04753; H01M 8/0494

(57) ABSTRACT

A method is for operating a commercial vehicle having a fuel cell system and an electromotive drive. The method includes: supplying reactants to a fuel cell of the fuel cell system, wherein the fuel cell is adapted to be operated at a changeable working point, activation of the fuel cell such that, via reaction of the supplied reactants, electrical energy is generated at a generated power, intermediate storage of the generated electrical energy at the corresponding power in a buffer store, and driving of the electromotive drive by withdrawal of electrical energy from the buffer store at a corresponding power. The method can further include: determination of weight information that is representative of the load state of the commercial vehicle, and adaptation of the working point in dependence on the determined weight information.

### CROSS-REFERENCE TO RELATED APPLICATIONS

This application is a continuation application of international patent application PCT/EP2022/080471, filed Nov. 2, 2022, designating the United States and claiming priority from German application 10 2021 128 751.0, filed Nov. 4, 2021, and the entire content of both applications is incorporated herein by reference.

### TECHNICAL FIELD

The disclosure relates to a method for operating a commercial vehicle having a fuel cell system and an electromotive drive, including supply of reactants to a fuel cell of the fuel cell system, wherein the fuel cell is adapted to be operated at a changeable working point, activation of the fuel cell for operation at a predetermined working point such that, via reaction of the supplied reactants, electrical energy is generated at a generated power, intermediate storage of the electrical energy generated by the fuel cell in a buffer store, and driving of the electromotive drive by withdrawal of electrical energy from the buffer store at a required power.

### BACKGROUND

The generated power is here understood as being the power that the fuel cell provides during operation. The required power is understood as being the power that the electromotive drive as the consumer requires from the buffer store.

Methods for operating commercial vehicles are generally known. One of the main reasons for the above-described method and the above-described layout of the commercial vehicles with a fuel cell and a buffer store arranged between the electric motor and the fuel cell is that the fuel cell, for technical reasons, cannot be subjected to arbitrarily pronounced load changes, and thus changes in the required power. Fuel cells can be operated most efficiently with operating parameters, that is, inter alia, operating temperatures, pressures, and supplied reactant quantities, that are as constant as possible. Prolonged operation of the fuel cell systems at high generated powers and thus high working points is as detrimental to the service life of the fuel cell as continual and abrupt changes of the working points.

During operation of the commercial vehicle, abrupt increases in the required power of the electromotive drives occur not only as a result of acceleration processes but also as a result of changed environmental conditions, such as, for example, changed route topographies.

These changed power requirements can be taken into account for driving the commercial vehicles by activating the fuel cell with a higher working point, wherein the loads and limitations of the service life of the fuel cell that occur as a result are perceived to be a disadvantage.

### SUMMARY

It is an object of the disclosure to mitigate the above-described disadvantages as far as possible. In particular, it is an object of the disclosure to improve the above-mentioned method by increasing the service life of the fuel cell without adversely influencing the operating properties of the commercial vehicle.

In the case of a method of the type mentioned at the beginning, the disclosure, for example, achieves the object by proposing that the method further includes: determination of weight information that is representative of the loading process of the commercial vehicle and adaptation of the working point in dependence on the determined weight information. The disclosure is based on the approach that not only is it necessary, in the case of a commercial vehicle, to move fundamentally higher vehicle masses than in the case of a passenger car, which can be moved comparatively dynamically, but that the overall mass of the vehicle also changes drastically, generally by significantly more than 100%, in dependence on the load state of the commercial vehicle. In the prior art it has been observed that, in the case of higher load requirements, for example in the case of acceleration processes or on inclines, when the commercial vehicle is fully loaded, a pronounced increase in the required power of the electromotive drive causes the buffer store to be discharged significantly more quickly, which made it necessary to readjust the working point of the fuel cell correspondingly severely in order to adapt the generated power. This put a great strain both on the buffer store and on the fuel cell. This is where the invention comes in, in that it actively calls up weight information that is representative of the load state of the commercial vehicle and adapts the working point in dependence on the weight information. Account is thus taken of the fact that the commercial vehicle in the fully loaded state requires a higher level, corresponding to the load, of electrical energy to be generated than an unloaded commercial vehicle. Because the invention in principle adapts the working point in dependence on the determined weight information, the fuel cell can be operated continuously at a (higher or lower) power level adapted to the weight, so that the need to manage acutely pronounced jumps in the working points is reduced. The service life of the fuel cell and of the buffer store is thus prolonged without the need for compromises in the operation of the commercial vehicle.

In an embodiment, the method is developed in that it includes the step:
adaptation of the working point of the fuel cell in accordance with an operating strategy,
wherein the operating strategy has a time profile and working points for activation of the fuel cell that vary along the time profile, and wherein the working points are adapted in dependence on the determined weight information. Operating strategies are already being used for other control purposes in the operation of commercial vehicles. They can be drawn up because it is generally already known even before the start of a journey how the commercial vehicle is to be moved over the forthcoming time profile and what loads it will be subject to, at least generally, during this time profile. The load state of the commercial vehicle is reflected at all working points along the time profile, which is why it can be included in the overall operating strategy via the determined weight information.

In a further embodiment, the method includes the steps:
determination of route information along the time profile, and
adaptation of the working points in dependence on the determined route information.

The route information forms part of the operating strategy. If it is already known before the start of a journey that the commercial vehicle has to climb a longer incline, for example a pass, after about one hour of operation, it is possible to plan beforehand in the context of the operating strategy that the working point is correspondingly adapted for the associated portion of the time profile. The working point can then be adapted in a forward-looking manner and more gradually than would have been possible in the prior art in the case of an unprepared journey along that section of the route.

Preferably, the route information can include one, a plurality or all of the following:
route topography,
traffic density information,
road covering information,
meteorological information.

The route topography can preferably be incorporated into the operating strategy such that different inclines and slopes along the time profile each correlate with individual working points which are adapted thereto and which, in the context of the operating strategy, can be passed through, preferably with smoothing, as constantly as possible. In this way, particular features along the route, for example inclines and slopes, no longer affect the fuel cell system in an unprepared manner.

Traffic density information can be incorporated into the operating strategy such that time portions along the time profile in which congestion, stop-and-go traffic or also regions of low traffic density and a high average speed are to be expected are allocated suitable working points for the expected required power.

Similarly, the road covering information can be incorporated into the operating strategy in that, for time portions along the time profile in which, for example, the commercial vehicle has to be moved over road coverings with a high rolling resistance, for example in the off-highway sector, corresponding adaptations are allocated to the working points for increased or reduced load requirements. Meteorological information can be incorporated into the operating strategy such that the working points of the fuel cell system can be adapted to temperature fluctuations and air pressure fluctuations which are to be expected in specific time portions of the above-mentioned profile.

In a further embodiment, the method is developed, in light of the above, with the step:
determination of a change in the required power of the electromotive drive along the time profile in dependence on the weight information and preferably additionally in dependence on the route information. For example, the weight information can be used as a proportional correction factor for an operating map of the fuel cell system.

Preferably, for time portions along the time profile in which the required power of the electromotive drive is increased, the working point or points is/are raised such that the raising thereof precedes in time the increase in the required power of the electromotive drive. In other words, the fuel cell is, as it were, able to raise the working points preventively in preparation for a time portion in which the power requirement is increased, namely such that they are also scaled sufficiently in accordance with the available weight information. Because the working points are raised in advance in time, the sudden increase in the load on the fuel cell is avoided, and a more constant profile in the change of the working points can be achieved, which benefits the service life of the fuel cell.

In the same way, for time portions along the time profile in which the required power of the electromotive drive is reduced, the working point or points can alternatively or additionally be lowered such that the lowering thereof precedes in time the reduction in the required power of the electromotive drive. Alternatively or additionally, for time portions along the time profile in which the required power is reduced, the working point or points is/are lowered such that the lowering thereof follows in time the reduction in the required power.

In a further embodiment, the weight information includes the overall mass of the commercial vehicle, and the determination of the weight information includes the acquisition of a resulting vehicle acceleration at a predetermined drive power of the electromotive drive, and calculation of the weight information as a function of the vehicle acceleration. Preferably, the calculation takes place via Newton's axioms, in particular via Newton's second axiom F=m×a, wherein F is the drive force, m is the vehicle mass, and a is the acceleration. Preferably, the actually implemented drive power of the electromotive drive, and thus the drive force that is responsible for the vehicle acceleration a, is acquired for this purpose. The drive power implemented by the drive corresponds to the required power minus all power losses which systematically occur in the electromotive drive as a result of the conversion of electrical energy into mechanical work. If the power loss is known, or estimated with sufficient accuracy, the required power can also be used for determining the drive force and can be offset, for example, with a predetermined allowance factor which characterizes the losses. Preferably, however, the actually implemented power of the electromotive drive is used. The drive force can be determined, for example, by reading out the motor torque of the electromotive drive. The acceleration is preferably determined via one or more acceleration sensors.

In a further embodiment, the commercial vehicle has an air suspension having a plurality of air springs, the weight information includes the payload of the commercial vehicle, and the determination of the weight information includes: acquisition of an air pressure and/or of an increase in the air pressures in the air springs, and calculation of the weight information as a function of the increase in the air pressure. Alternatively or additionally, the method includes a plausibility check of the determined weight information via the acquisition of the air pressure of the air springs.

In further embodiments, the determination of the weight information includes the acquisition of parameter signals that are representative of the load state of the commercial vehicle, determination of the weight information in dependence on these parameter signals. As described above, the parameter signals can be acceleration data or pressure data, but they may also be, for example, distance or angle change signals which are acquired by sensor devices of the commercial vehicle as a function of a weight-induced relative movement between the vehicle structure and the chassis.

Preferably, the commercial vehicle has a towing vehicle and a trailer, and the weight information is determined for the towing vehicle and the trailer separately, or alternatively together.

In a further embodiment in which the commercial vehicle has the towing vehicle and the trailer, the towing vehicle and the trailer are reversibly detachably connected to one another via a trailer coupling, and the method includes:
determination of a coupling state of the trailer coupling and:
in the coupled state, allocation of a general weight value in respect of the weight information that is representative of a given mass of the trailer, or raising of the working points by a predetermined value independently of the weight information, for example in a region of 10% or more, in particular 20% or more; and/or
in the uncoupled state, allocation of a weight value that corresponds to a parameterized vehicle weight.

An advantage of this embodiment is that data processing is simplified significantly. The weight classes of the trailers are easy to determine and in many operating scenarios ensure sufficient adaptation of the operating strategy of the fuel cell system even without an accurate weight determination being carried out.

In a further embodiment, the commercial vehicle has a cooling system which is adapted to dissipate heat energy from the fuel cell system via a cooling power, and the method further has the step:
adaptation of the cooling power in dependence on the determined weight information.

When the commercial vehicle is operated with a higher load, the fuel cell system must in principle supply more power and consequently also requires more cooling power. Because the cooling power correlates with the power that is to be retrieved from the fuel cell system and thus also correlates with the load state of the commercial vehicle, the inclusion of the weight information in the adaptation of the cooling power has an advantageous effect on the performance and at the same time on the operational reliability of the fuel cell system.

In a further embodiment, the commercial vehicle is adapted, in a regeneration mode, to activate the electromotive drive as a generator in order to recover electrical energy corresponding to a regenerated power via a regenerated power and supply it to the buffer store, and the method further includes adaptation of the regenerated power in dependence on the determined weight information. Just as the commercial vehicle requires more power when, with a higher load, it has to climb an incline, more energy can also be recovered when a vehicle with a higher load travels down a slope. By taking account of the weight information, and preferably the route information, the load point for the fuel cell can thus also be shifted downward and the activation of the electromotive drive as a generator can be correspondingly adapted.

The invention has been described in a first aspect via the method according to the disclosure. In a further aspect, the disclosure relates also to a commercial vehicle having a fuel cell system and an electromotive drive, having a fuel cell which is adapted to receive reactants and is able to be operated at a changeable working point, a control device which is connected in a signal-carrying manner to the fuel cell and is adapted to activate the fuel cell for operation at a predetermined working point such that, via reaction of the supplied reactants, electrical energy is generated at a generated power, a buffer store which is adapted to intermediately store the generated electrical energy, wherein the electromotive drive is adapted to be driven at a required power by withdrawal of electrical energy from the buffer store.

In the case of such a commercial vehicle, the disclosure achieves the underlying object in that the commercial vehicle has means for determining weight information, wherein the weight information is representative of the load state of the vehicle, and in that the control device is adapted to adapt the working point in dependence on the determined weight information. In particular, the control device is adapted to carry out the method according to the embodiments described above.

The invention benefits from the same advantages in this respect as the method according to the first aspect of the disclosure.

The above embodiments of the method are thus at the same time embodiments of the commercial vehicle and vice versa. In this respect, reference is also additionally made to the above observations.

The disclosure according to the second aspect is accordingly preferably developed in that the control device is adapted to perform one, a plurality or all of the following functions:
adaptation of the working point of the fuel cell in accordance with an operating strategy, wherein the operating strategy has a time profile and working points for activation of the fuel cell that vary along the time profile, and wherein the working points are adapted in dependence on the determined weight information;
determination of route information along the time profile, and adaptation of the working points in dependence on the determined route information, wherein the route information preferably includes one, a plurality or all of the following:
   route topography,
   traffic density information,
   road covering information,
   meteorological information;
determination of a power requirement of the electromotive drive that varies along the time profile, in dependence on the weight information and preferably additionally in dependence on the route information; wherein preferably, for time portions along the time profile in which the required power of the electromotive drive is increased, the working points are raised such that the raising thereof precedes in time the increase in the required power of the electromotive drive, and/or wherein preferably, for time portions along the time profile in which the required power of the electromotive drive is reduced, the working points are lowered such that the lowering thereof precedes in time the reduction in the required power of the electromotive drive;
acquisition of a resulting vehicle acceleration at a known drive power of the electromotive drive, and calculation of the weight information as a function of the vehicle acceleration, wherein the weight information includes the overall mass of the commercial vehicle;
acquisition of an increase in air pressures in air springs, and calculation of the weight information as a function of the increase in the air pressure, wherein the commercial vehicle has an air suspension having the air springs, and the weight information includes the payload of the commercial vehicle;
determination of the weight information for a towing vehicle and a trailer separately, or together, wherein the commercial vehicle has the towing vehicle and the trailer;
determination of a coupling state of a trailer coupling and, in the coupled state, allocation of a general weight value in respect of the weight information that is representative of a given mass of the trailer, or raising the working points by a predetermined value independently of the weight information;
adaptation of a cooling power in dependence on the determined weight information, wherein the commercial vehicle has a cooling system which is adapted to dissipate heat energy from the fuel cell system via the cooling power;
adaptation of a regenerated power in dependence on the determined weight information, wherein the commercial vehicle is adapted, in a regeneration mode, to activate the electromotive drive as a generator in order to recover electrical energy corresponding to the regenerated power and supply it to the buffer store.

In an embodiment of the commercial vehicle, the fuel cell system has a fuel cell controller, and the control device is integrated partially or completely in the fuel cell controller. The integration can be hardware-based or software-based. The control device can alternatively or partially additionally be configured as a dedicated control apparatus, or as a distributed arrangement of a plurality of control apparatuses which each perform one or more of the above-mentioned functions.

The data processing unit can have a dedicated hardware unit having one or more data interfaces for receiving and for outputting data, a processor, preferably a data memory. In an embodiment, the control device is connected to the data processing unit, preferably via a data interface and a data communication network, and is adapted to receive the weight information, and/or information elements for determining the weight information, via the data interface, and further has a processor for processing the received information or information elements, in particular in a method according to one of the embodiments described above, or via one, a plurality or all of the functions described above.

The information elements in particular include the above-described parameter signals that are representative of the load state of the commercial vehicle.

In various embodiments, the data processing unit is adapted to receive from one or more sensor devices parameter signals that are representative of the load state of the commercial vehicle and to determine the weight information in dependence on these parameter signals. In order to avoid repetition, reference is made in this connection to the above explanations relating to the method.

The data communication network can have, for example, a bus system, for example a CAN bus.

Alternatively, the data processing unit can be integrated in the control device.

### BRIEF DESCRIPTION OF DRAWINGS

The invention will now be described with reference to the drawings wherein:

FIG. 1 is a schematic representation of a commercial vehicle according to an embodiment; and,

FIG. 2 is a schematic representation of an operating strategy for operation of the commercial vehicle according to FIG. 1.

### DETAILED DESCRIPTION

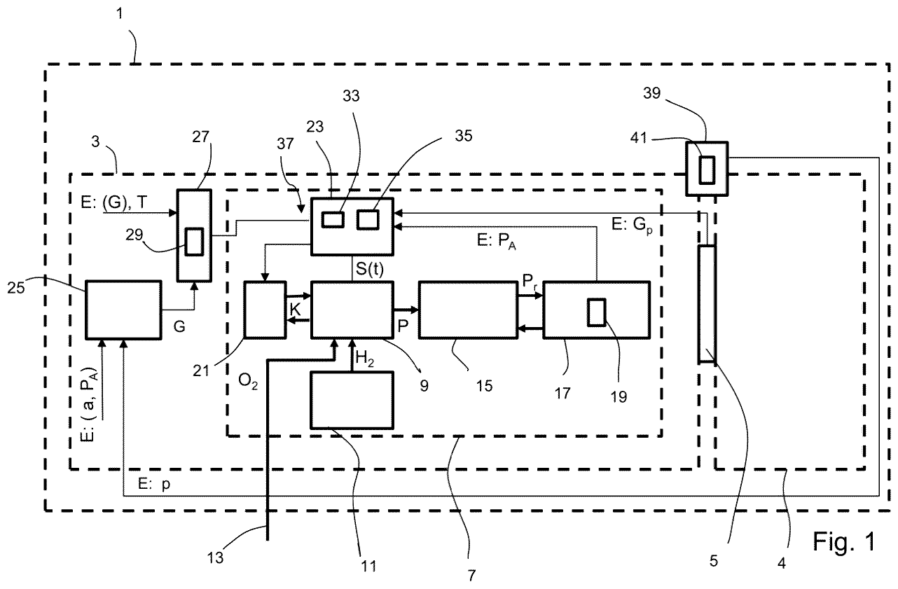

FIG. 1 shows a commercial vehicle 1 according to an embodiment of the disclosure. The commercial vehicle 1 has a towing vehicle 3 and a trailer 4, which are reversibly detachably coupled with one another via a trailer coupling 5.

The commercial vehicle 1 further has a fuel cell system 7, which by way of example is shown as part of the towing vehicle 3. This is not necessarily the case. The fuel cell system 7 includes a fuel cell 9, which is connected in a fluid-conducting manner on the anode side to a hydrogen reservoir 11 and on the cathode side to an air supply 13, which is adapted, for example, to supply ambient air.

The fuel cell 9 is adapted to react the reactants H₂, O₂ supplied thereto and to generate electrical energy with a generated power P. It is not necessary here to supply pure oxygen; oxygen-containing substance mixtures such as, for example, ambient air can also be supplied.

The fuel cell 9 is electrically conductively connected to a buffer store 15 and is adapted, in dependence on the generated power P that it provides, to intermediately store electrical energy in the buffer store 15.

The buffer store 15 is electrically conductively connected to an electromotive drive 17. The electromotive drive 17 has an electric machine 19, which can be activated both as an electric motor and as a generator. In a normal operating mode, the electric machine 19 is activated as an electric motor and serves for propulsion of the commercial vehicle 1. For driving the electromotive drive 17, the electromotive drive requires a required power Pᵣ, and the necessary electrical energy, which is dependent on the required power Pᵣ, is withdrawn from the buffer store 15. The electromotive drive 17 is thus adapted to be driven by withdrawal of electrical energy from the buffer store 15. In a regeneration mode, the electric machine 19 can be activated as a generator and provides for the recovery of electrical energy and intermediate storage thereof in the buffer store 15.

The fuel cell 9 is connected in a fluid-conducting manner to a cooling system 21, wherein the cooling system 21 is adapted to remove heat from the fuel cell 9, and optionally from further components of the fuel cell system, via circulation of a cooling medium by application of a cooling power K.

The fuel cell 9 can be operated at changeable working points A₁ . . . Aₙ and has for this purpose a control device 23 which is connected in a signal-carrying manner to the fuel cell 9 and is adapted to activate the fuel cell 9 for operation at a predetermined working point A₁ . . . Aₙ such that, via reaction of the supplied reactants H₂, O₂, electrical energy is generated.

The commercial vehicle 1 further has a data processing unit 25 for determining weight information G, wherein the weight information G is representative of the load state of the commercial vehicle 1. The data processing unit 25 is shown in FIG. 1 as a dedicated hardware unit. It may, however, also be integrated in the control device 23.

The control device 23 is adapted to adapt the working point A₁ . . . Aₙ in dependence on the determined weight information G. If the data processing unit 25 and the control device 23 are independent units, a data communication network 27 is preferably provided for communication between the data processing unit 25 and the control device 23, which data communication network can have a CAN bus 29, for example, and to which both the control device 23 and the data processing unit 25 for determining the weight information G are connected in a signal-carrying manner. Alternatively, a direct connection would also be conceivable.

The data processing unit 25 for determining the weight information G is adapted to provide the weight information G. To that end, the data processing unit 25 is adapted to receive from one or more sensor devices (not shown) information elements E, in particular parameter signals, that are representative of the load state of the commercial vehicle, and to determine the weight information in dependence on these parameter signals. The parameter signals can include, for example, data that are representative of acceleration values, pressures and the like, see below.

The electronic control device 23 preferably has one or more processors 33 for data processing as well as, further preferably, a data memory 35 in which the commands for controlling the fuel cell system 7 are stored.

The electronic control device 23 can be a dedicated control apparatus, or it can be integrated as hardware and/or software in an existing fuel cell controller of the fuel cell 9. Alternatively, the control device 23 can be integrated in a brake control device (EBS) of the towing vehicle 3 or in a brake control device (TEBS) of the trailer 4.

For communication with the data communication network 27, the control device 23 has a data interface 37.

The commercial vehicle 1 optionally has an air suspension 39 having one or more air springs 41, which can be associated with the towing vehicle 3 and/or with the trailer 4.

Since the structural layout of the commercial vehicle 1 has been explained above, the use of the commercial vehicle 1, or of the fuel cell system 7, will be discussed below.

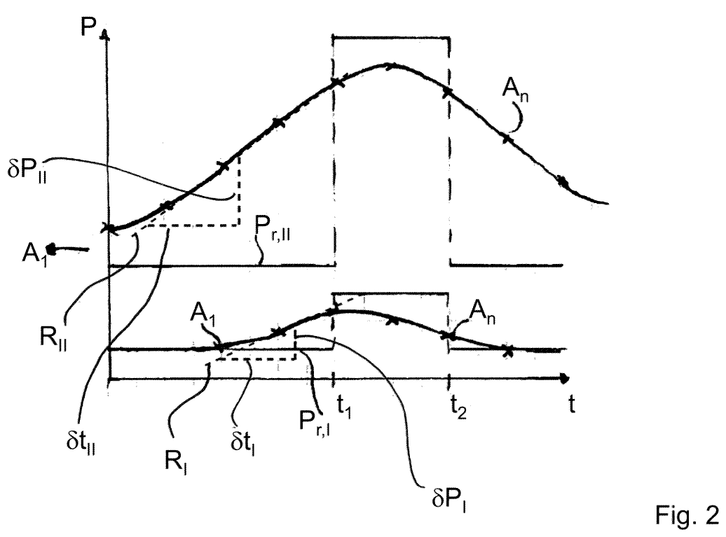

If the commercial vehicle 1 is to be moved, it is necessary to supply electrical energy to the electromotive drive 17. A required power Pᵣ is required to activate the electromotive drive 17 and is provided by the buffer store 15. In order that the buffer store 15 is not emptied, the control device 23, which is connected in a signal-carrying manner to the electromotive drive 17 and to the fuel cell 9, instructs the fuel cell 9 to provide a generated power P and to generate electrical energy in order to maintain the load state of the buffer store 15. To that end, by setting the operating parameters of the fuel cell 9, inter alia the required reactant equilibrium and the required reactant quantity, a working point A₁ . . . Aₙ of the fuel cell 9 is set, and electrical energy is supplied to the buffer store 15 according to this working point A₁ . . . Aₙ. According to the disclosure, the determination of a correct working point A₁ . . . Aₙ additionally includes the weight information G, which is made available to the control device 23, preferably via its data interface 37. Knowledge of the weight information G allows the working point A₁ . . . Aₙ to be set from the outset at a level that is appropriate for the actual vehicle mass, or the actual load state of the vehicle. This is illustrated by way of example in FIG. 2.

FIG. 2 shows, schematically, a time profile t for a required power P_{r,I} for an unloaded commercial vehicle 1, and in addition, schematically, a time profile of a required power P_{r,II} for a fully loaded commercial vehicle. Owing to the higher vehicle load, a higher required power is necessary to operate the vehicle at P_{r,II}, and by taking this weight information into account, the first working point A₁ can already be set higher for the required power P_{r,II} than would be necessary if the vehicle was only being driven travelling, as indicated by the required power P_{r,I}.

In the case of a non-predictive system, the fuel cell would work at a constant working point, and only if the required power Pᵣ of the electromotive drive rose and the load state of the buffer store 15 changed would the fuel cell change, in response to the changed load requirement, to operation at an increased working point and provide a higher generated power P.

By contrast, the disclosure proposes to adapt the working points A₁ . . . Aₙ during operation of the commercial vehicle in dependence on the determined weight information G, namely on the basis of an operating strategy S(t).

Thus, in the context of the operating strategy S(t), the time profile P_{r,I} or P_{r,II} of the required power of the electromotive drive is pre-known and entered into the control device 23, for example stored in the data memory 35 thereof. In particular, the route that is to be followed along the time profile, which characterizes the required power Pᵣ, is known. Together with the weight information G of the vehicle, it is readily possible to estimate the point along the time profile of a forthcoming journey at which increased power will be required by the electromotive drive 17, in the examples of FIG. 2 between t₁ and t₂. On the basis thereof, the working point profile A₁ . . . Aₙ of the fuel cell can be changed.

The magnitude of the increase in the required power Pᵣ of the electromotive drive 17, and thus the need for adaptation of the generated power of the fuel cell 9, is in turn dependent on the load state of the commercial vehicle 1, which can advantageously be mapped by determining the weight information G.

As can be seen in FIG. 2, the increase in the required power Pᵣ correspondingly carries less weight in the case of a higher vehicle mass. For illustration, FIG. 2 shows a first ramp R_{I}, which characterizes the greatest rate of increase of the power δP_{I}/δt_{I} of the fuel cell of an unloaded vehicle, and a second ramp R_{II}, which characterizes the greatest rate of increase of the power δP_{II}/δt_{II} of the fuel cell of a loaded vehicle. Owing to the inclusion of the weight information G, see FIG. 1, the rate of increase, that is, the steepness of the ramp R_{I} or R_{II}, can be controlled such that it is appropriate but sufficiently flat, so that a load dynamics which potentially occurs as a result of the jumps in the required power Pᵣ is limited, because the extent of the jump in the required power Pᵣ is already known, as a result of the determination of the weight information G, before the jump occurs.

This can be taken into account by inclusion of the operating strategy S(t): The control device 23 begins to raise the working points A₁ . . . Aₙ in dependence on the weight information G in advance in time, namely before time t₁, in order to limit the dynamics of the fuel cell 9 and nevertheless be able to deliver sufficient electrical energy to the buffer store 15.

In addition to the weight information G, the operating strategy S(t) can include, as further information elements E, all the information that is available to the data communication network 27 of the commercial vehicle and that can have an effect on the required power Pᵣ of the electromotive drive 17, such as, for example, route information T along the time profile, for example the route topography, traffic density information, road covering information or meteorological information. The route information T is present in the data communication network 27 and is determined in the generally known manner via sensors (not shown) or is inputted manually.

Just as an increasing required power is determined along the time profile, a falling required power can also be determined along the time profile, thus also in FIG. 2 at time t₂. While the power requirement, that is, the required power Pᵣ, increases at time t₁, it decreases at time t₂. In the present example, the required power Pᵣ falls to the level prior to time t₁.

Analogously to the control method above, the control device 23 instructs the fuel cell 9, preferably in advance in time, to gradually lower the working points Aₙ, preferably constantly, and thus again limit the dynamics of the change of the working points of the fuel cell 9.

The weight information is preferably calculated in the data processing unit 25 or in the control device 23. To this end there is transmitted to the unit in question, for example via the data communication network 27, in an embodiment as an information element E a representative characteristic in respect of a vehicle acceleration a. In addition, a representative characteristic in respect of the actually implemented drive power P_{A} of the electromotive drive 17, and thus the drive force which is responsible for the vehicle acceleration a, should preferably also be known. This information can be obtained, for example, by reading out the motor torque of the electromotive drive 17.

P_{A}, minus power losses and thus in dependence on the efficiency of the electromotive drive, will correspond to the required power Pᵣ.

The overall mass of the vehicle can be calculated as the weight information G from the known drive power P_{A} and the known vehicle acceleration a and can be used for the adaptation of the operating strategy S(t).

Particularly preferably, the weight information is determined via the equation F=m×a, wherein m is the calculated overall mass of the vehicle, the acceleration a is acquired via sensors, and the force F is determined from the drive power, in particular the motor torque (see above).

According to the disclosure, for the determination—or plausibility check—of the weight information G, the air pressures p in the air springs 41 of the air suspension 39 can also be read out. The change in the payload of the vehicle can be determined via a change in the air pressure. The air pressure p is preferably transmitted as a parameter signal to the data processing unit 25 and is correspondingly processed in the data processing unit 25.

The weight information G does not have to be determined via sensors or calculated; in an alternative embodiment it can also be determined externally to the vehicle, for example at a weighbridge, or can be inputted manually and made available to the control device 23 via the data communication network 27, for example.

A further possibility for including the weight information in the operating strategy S(t) can be implemented such that the coupling state of the trailer coupling 5 between the towing vehicle 3 and the trailer 4 is monitored by the control device 23. If the control device 23 determines that the trailer coupling 5 is in its coupling state, there is used for the operating strategy S(t) a general weight value Gₚ for the weight information G that is representative of a towing vehicle 3 having a trailer 4 with a defined load, for example half-full or full. If the control device 23 determines that the trailer coupling 5 is in an uncoupled state, a general weight value Gₚ that is representative of operation of the towing vehicle 3 without a trailer 4 is allocated to the weight information G. This distinction between cases is very easy to implement in terms of programming and in most driving situations results in a functional operating strategy which achieves the advantages of the disclosure to a high degree.

Knowledge of the weight information G can be used not only to adapt the working points A₁ . . . Aₙ of the fuel cell 9. Preferably, the control unit 23 additionally controls the cooling power K of the cooling system 21 in dependence on the determined weight information G, so that the fuel cell 9 and any further components are cooled adequately even at the adapted working points.

A number of possibilities for determining the weight information have been described above. The disclosure can be used with a combination of a plurality or all of these possibilities, but it can also be implemented by selecting only one of these possibilities.

It is understood that the foregoing description is that of the preferred embodiments of the invention and that various changes and modifications may be made thereto without departing from the spirit and scope of the invention as defined in the appended claims.

### LIST OF REFERENCE NUMERALS (PART OF THE DESCRIPTION)

1 commercial vehicle
3 towing vehicle
4 trailer
5 trailer coupling
7 fuel cell system
9 fuel cell
11 hydrogen reservoir
13 air supply
15 buffer store
17 drive
19 electric machine
21 cooling system
23 control device
25 data processing unit (determination of weight information)
27 data communication network
29 CAN bus
33 processor
35 data memory
37 data interface
39 air suspension
41 air spring
a acceleration
(A₁, Aₙ) working points
E information element
H₂, O₂ reactants
G weight information:
Gₚ general weight value
K cooling power
P pressure, air springs
P generated power, fuel cell
P_{A} implemented drive power, electromotive drive
Pᵣ required power, electromotive drive
S(t) operating strategy
t time profile
T route information

1. A method for operating a commercial vehicle having a fuel cell system and an electromotive drive, the method comprising:
supplying reactants to a fuel cell of the fuel cell system, wherein the fuel cell is configured to be operated at a changeable working point;
activating the fuel cell such that, via a reaction of the supplied reactants, electrical energy is generated at a generated power;
intermediately storing the generated electrical energy in a buffer store;
driving the electromotive drive by withdrawal of electrical energy from the buffer store at a required power;
determining weight information that is representative of a load state of the commercial vehicle; and,
adapting the working point in dependence upon the determined weight information.

2. The method of claim 1 further comprising:
adapting the working point of the fuel cell in accordance with an operating strategy;
wherein the operating strategy has a time profile and working points for activation of the fuel cell that vary along the time profile; and,
wherein the working points are adapted in dependence upon the determined weight information.

3. The method of claim 2 further comprising:
determining route information along the time profile; and,
adapting the working points in dependence upon the determined route information.

4. The method of claim 2 further comprising determining a change along the time profile of the required power of the electromotive drive in dependence upon the weight information.

5. The method of claim 3 further comprising determining a change along the time profile of the required power of the electromotive drive in dependence upon the weight information and additionally in dependence upon the route information.

6. The method of claim 4, wherein, for time portions along the time profile in which the required power of the electromotive drive is increased, the working points are raised such that the raising thereof precedes in time the increase in the required power of the electromotive drive.

7. The method of claim 4, wherein, for time portions along the time profile in which the required power of the electromotive drive is reduced, the working points are lowered such that the lowering thereof precedes or follows in time the reduction of the required power of the electromotive drive.

8. The method of claim 1, wherein said determining of the weight information includes:
acquiring parameter signals that are representative of the load state of the commercial vehicle; and,
determining the weight information as a function of the parameter signals.

9. The method of claim 8, wherein the weight information includes an overall mass of the commercial vehicle, and said determining the weight information includes:
acquiring a resulting vehicle acceleration of the electromotive drive; and,
calculating the weight information as a function of the vehicle acceleration.

10. The method of claim 8, wherein the commercial vehicle has an air suspension having a plurality of air springs, the weight information includes a payload of the commercial vehicle, and said determining the weight information includes:
acquiring an increase in the air pressures in the air springs; and,
calculating of the weight information as a function of the increase in the air pressure.

11. The method of claim 1, wherein the commercial vehicle has a towing vehicle and a trailer, and the weight information is determined for the towing vehicle and the trailer separately, or together.

12. The method of claim 1, wherein the commercial vehicle has a towing vehicle and a trailer which are reversibly detachably connected to one another via a trailer coupling, and the method further comprises:
determining a coupling state of the trailer coupling, and at least one of:
in the coupled state, allocating a general weight value with respect to the weight information that is representative of a given mass of the trailer, or raising the working point by a predetermined value independently of the weight information; and,
in the uncoupled state, allocating the weight value that corresponds to a parameterized vehicle weight.

13. The method of claim 1, wherein the commercial vehicle has a cooling system configured to dissipate heat energy from the fuel cell system via a cooling power, and the method further comprises:
adapting of the cooling power in dependence upon the determined weight information.

14. A commercial vehicle comprising:
a fuel cell system;
an electromotive drive;
a fuel cell configured to receive reactants and to be operated at a changeable working point;
a control device connected in a signal-carrying manner to said fuel cell and being configured to activate said fuel cell for operation such that electrical energy is generated at a generated power via a reaction of the supplied reactants;
a buffer store configured to intermediately store the generated electrical energy;
said electromotive drive being configured to be driven with a required power by withdrawal of electrical energy from said buffer store;
a data processing unit configured to determine weight information, wherein the weight information is representative of a load state of the commercial vehicle; and,
said control device being configured to adapt the working point in dependence upon the determined weight information.

15. The commercial vehicle of claim 14, wherein said control device is connected to said data processing unit and is configured to receive at least one of the weight information and information elements for determining the weight information; and, said control device has a processor for processing the at least one of the weight information and the information elements for determining the weight information.

16. The commercial vehicle of claim 14, wherein said control device is connected to said data processing unit via a data interface and a data communication network of the commercial vehicle; and, said control device is configured to receive at least one of the weight information and information elements for determining the weight information and has a processor for processing the at least one of the weight information and the information elements for determining the weight information.

17. The commercial vehicle of claim 14, wherein said control device is connected to said data processing unit and is configured to receive at least one of the weight information and information elements for determining the weight information; and, said control device has a processor configured to:
cause the reactants to be supplied to said fuel cell, wherein the fuel cell is configured to be operated at the changeable working point;
activate the fuel cell such that, via the reaction of the supplied reactants, electrical energy is generated at the generated power;
intermediately store the generated electrical energy in the buffer store;
drive the electromotive drive by withdrawal of electrical energy from the buffer store at the required power;
determine weight information that is representative of the load state of the commercial vehicle; and,
adapt the working point in dependence on the determined weight information.

18. The commercial vehicle of claim 14, wherein said data processing unit is configured to receive from one or more sensor devices parameter signals representative of the load state of the commercial vehicle, and to determine the weight information in dependence upon the parameter signals.
